(19) United States
(12) Patent Application Publication
(10) Pub. No.: US 2014/0062121 A1
(43) Pub. Date: Mar. 6, 2014

(54) PLASTIC MOULDINGS FOR USE AS WINDOWS FOR CARS OR UTILITY VEHICLES

(71) Applicants: Gunther Benz, Griesheim (DE); Lawrence N. Gabriel, E. Stroudsburg, PA (US); Stephen A. Ferrero, Seligenstadt (DE)

(72) Inventors: Gunther Benz, Griesheim (DE); Lawrence N. Gabriel, E. Stroudsburg, PA (US); Stephen A. Ferrero, Seligenstadt (DE)

(73) Assignees: Evonik Cyro LLC, Parisippany, NJ (US); Evonik Roehm GmbH, Darmstadt (DE)

(21) Appl. No.: 14/008,341

(22) PCT Filed: Mar. 12, 2012
(86) PCT No.: PCT/EP12/54185

§ 371 Date: Nov. 22, 2013

Related U.S. Application Data
(60) Provisional application No. 61/468,139, filed on Mar. 28, 2011.

(51) Int. Cl. B60J 1/00; C08L 33/12

(52) U.S. Cl. CPC B60J 1/00; C08L 33/12
USPC 296/84.1; 427/402

(57) ABSTRACT

The invention relates to the use of coated mouldings consisting of impact modified polymethacrylate with high molecular weight as windows for passenger cars or utility vehicles.

### FIELD OF THE INVENTION

The invention relates to the use of coated mouldings consisting of impact modified polymethylmethacrylate polymers with high molecular mass as windows for passenger cars or utility vehicles.

### PRIOR ART

Impact-modified poly(meth)acrylat moulding compositions are known, and are marketed by Evonik Röhm GmbH, for example with the grade names PLEXIGLAS®zkBR, PLEXIGLAS® zkHC, PLEXIGLAS®zkHT, PLEXIGLAS®zkHF, and PLEXIGLAS® zk. Said moulding compositions are used for extrusion or injection moulding of products used as household articles, lamp covers, sanitary items or roofing material. The brochure “Schlagzähe PLEXIGLAS®-Formmassen” [Impact-modified PLEXIGLAS® moulding compositions] from Röhm GmbH & Co. KG (No. 10/1001/06003 (d)) gives information on the other properties, such as Vicat softening point (B/50) (ISO 306), and Charpy impact and Charpy low-temperature impact strength (ISO 179).

Mouldings of poly(meth)acrylate may also be produced by polymerization of (meth)acrylate and, where appropriate, other monomers and auxiliaries in the cell(-casting) process. Polymers obtained by a cell cast process, which are commercially available as PLEXIGLAS®GS grades, exhibits a higher-molecular-weight compared to polymers used for extrusion or injection moulding. Polymers produced by a cast process are not capable of further being processed by extrusion or injection moulding. Instead forming methods used for casted sheets are either machining or thermoforming.

Similar qualities to the PLEXIGLAS® grades mentioned above are also supplied by other producers. The following Table 1 compares the properties of PLEXIGLAS® GS and PLEXIGLAS®XT:

TABLE 1

| PLEXIGLAS ®GS | PLEXIGLAS ®XT |
|---|---|
| Cast | Extruded |
| Absolutely colourless and | Absolutely colourless and |
| clear | clear |
| Fracture-resistant | Fracture-resistant to |
| | impact-modified (RESIST) |
| Unequalled weathering and | Unequalled weathering and |
| ageing resistance | ageing resistance |
| High-quality surface and | Very good surface |
| planarity | |
| Solid sheets, blocks | Solid sheets, pipes, rods, |
| pipes, rods and bars | multiwall sheets, |
| | corrugated sheets, mirrors |
| From 2 to 200 mm solid | From 1.5 to 25 mm thickness |
| thickness | for solid sheets, 16 and |
| | 32 mm for multiwall sheets |
| Good resistance to dilute | Good resistance to dilute |
| acids | acids |
| Limited resistance to | Limited resistance to |
| organic solvents | organic solvents |
| Good resistance to alkali | Good resistance to alkali |
| Very easy to work, similar | Easy to work, similar to |
| to hardwood | hardwood |
| Easily thermoformable with | Very easy to thermoform |
| wide processing latitude | under ideal consistent |
| | conditions |
| Capable of very good and | Capable of very good |
| secure adhesion, e.g. | adhesion, and this includes |
| using reactive adhesives | the use of solvent-based |
| (e.g. ACRIFIX ®190, 192) | adhesive (e.g. ACRIFIX ®116, |
| | 117) |
| Capable of combustion | Capable of combustion |
| approximately as hardwood; | approximately as hardwood; |
| very little smoke | very little smoke generated |
| generated | |
| Usable up to about 80° C. | Usable up to about 70° C. |

So far, neither mouldings of casted nor of extruded polymethylmethacrylate could be used as windows for passenger cars or for utility vehicles. Even though there has been no lack of attempts to use polymethylmethacrylate mouldings as windows in cars and trucks, the strong requirements for impact resistance, noise vibrations, and haze level at elevated temperatures of the automotive industry have not been met, yet. Thus, windows made from glass are nearly exclusively used.

Since use of plastic windows may lead to weight savings of up to 50% compared to glass windows, there is still a demand for new plastic materials for windows in this field of application.

### OBJECT

An object of the present invention was to provide new windows for cars and or utility vehicles with significant weight savings compared to glass windows.

A specific object of the present invention was to provide a weight saving rear window for cars and utility vehicles. Said rear window should in particular fulfill the requirements for haze at elevated temperatures as reached if the rear window defogger is activated.

Production of the novel windows should be possible on existing machinery without major modification.

Further objects not explicitly mentioned can easily be derived from the over all context of the present invention.

### ACHIEVEMENT OF OBJECT

It has been found that a coated plastic moulding comprising an impact-modified polymethylmethacrylate based matrix polymer with very high molecular mass, which is coated with at least one abrasion resistance and/or weathering resistance coating may be used as window in passenger cars or utility vehicles.

The plastic mouldings of the invention can in particular be used as rear window or as front window because they fulfill the haze requirements at elevated temperature.

The inventive windows the specifications with regard to impact tests and noise vibration of the automotive industry.

Scratch resistance and weathering resistance coatings ensure good visibility even after long term use.

The inventive windows may also be used as panoramic roof window because they are easy to be coloured.

Object of the present invention are therefore windows for passenger cars or utility vehicles comprising a coated plastic moulding,
wherein the plastic moulding is made from a polymethylmethacrylate based polymer having a molecular mass of at least 750.000 g/mol and comprising an impact modifier,

and
wherein the plastic moulding is coated with at least one abrasion resistance and/or weathering resistance coating.

Before the invention is described in detail, important terms are defined.

The terms “passenger cars” and “cars” are used synonymously. They cover all known types of cars from small cars to huge ones, like SUVs or pickup trucks.

The term “utility vehicle” covers all kinds of utility vehicles moving on land like trucks, busses, construction vehicles, agriculture and forest equipment and all related vehicles.

The term (meth)acrylate covers acrylates as well as methacrylates and mixtures or blends thereof.

The matrix polymer of the inventive plastic mouldings is a polymethylmethacrylate based polymer with very high molecular mass as obtained by a cast process, preferably a cell casting or continuous casting process. Said polymer differs from a polymethylmethacrylate based polymer as used for extrusion or injection moulding because of its much higher molecular mass. Polymers as used for extrusion or injection moulding and also mouldings as obtained by extrusion or injection moulding cannot be used for windows for cars or utility vehicles even if huge amounts of impact modifiers were added. Consequently the matrix polymers of the present invention have a molecular mass of at least 750.000 g/mol, preferably at least 1.000.000 g/mol, particular preferred more than 1.500.000 g/mol, very particular preferred more than 2.000.000 g/mol and especially preferred 2.500.000 g/mol to 6.000.000 g/mol.

The inventive plastic mouldings comprise impact modifiers. They therefore differ from conventional high molecular mass (cell)cast polymers which are not impact modified. The inventors found out, that a high molecular mass alone is not sufficient to fulfill the requirements of the automotive industry. As demonstrated in the examples below, conventional mouldings obtained by a cast process did not pass the “Headform” test. Only impact modified polymers with sufficiently high molecular mass showed excellent results.

The inventive mouldings can be obtained by dissolving impact modifier or impact-modifier-containing polymethylmethacrylate in methylmethacrylate or in methylmethacrylate which has undergone incipient polymerization (syrup) and then pouring the solution into a cell or between steel belts and polymerizing the same by the processes known per se. The casting process is described by way of example in “Kunststoff-Handbuch” [Plastics handbook], Vol. IX, p. 15, Carl Hanser Verlag, 1975 or in “Ullmanns Enzyclopädie der technischen Chemie” [Ullmann's encyclopaedia of industrial chemistry], Vol. 19, p. 22, 4th Edition, Verlag Chemie (198).

By these processes mouldings are obtained, having the properties of conventional cast polymers like PLEXIGLAS®GS moulding known per se but with increased impact strength, excellent weathering and ageing resistance, resistance to chemicals and hot water, optical brilliance and good formability.

To further improve the resistance against chemical and physical impacts on the inventive windows, the inventive mouldings are coated with at least one coating. Dependent on the intended use, coatings improving abrasion resistance and/or weathering resistance are applied to the outer surface of the inventive mouldings. Even though the cast products themselves exhibit good mechanical and chemical resistance, abrasion resistance coatings are important for in particular windows to allow cleaning and ice scraping without damaging of the surface of the window.

The coating applied to the inventive moulding may combine different properties like scratch resistance, abrasion resistance, weathering resistance, UV protection etc.

In principle all known coating in the art, having the desired properties and suitable to be coated on PMMA-sheets can be used. Preferred abrasion resistance coatings are for example described in DE 3134777. Further coatings that can be used are disclosed in DE 4319199, DE 19507174, DE 10002059.

The matrix material used in the process of the invention is a polymethylmethacrylate based polymer. Polymethylmethacrylate based means that the main ingredient is methylmethacrylate.

The inventive polymethylmethacrylate based polymers may be obtained by cast polymerization of monomer mixtures comprising at least 50% by weight, preferably 60 to 100%, particular preferred 70 to 99% by weight, especially preferred 75 to 97% by weight and very much preferred 80 to 95% by weight, based on the weight of the matrix cast solution respectively matrix syrup, of methylmethacrylate. The monomer mixture may further comprise other (meth)acrylates or (alkyl) (meth)acrylates copolymerizable with methylmethacrylate. Such monomers are known in the art.

The monomer mixture may further comprise 0 to 10% by weight, preferably 0 to 5% by weight and particular preferred 0 to 3% by weight, based on the weight of the cast solution respectively syrup, of unsaturated carboxylic acids. Preferred examples of unsaturated carboxylic acid which may be used are methacrylic acid and acrylic acid.

It may further be beneficial to improve the mechanical and optical properties of the mouldings by addition of 0 to 2% by weight, preferably 0 to 1.5% by weight and particular preferred 0 to 1% by weight, based on the weight of the cast solution respectively syrup, of crosslinkers to the monomer mixture. Preferred examples of compounds which may be used as crosslinker are glycol dimethacrylate, allylmethacrylate and triallyl cyanurate.

The monomer mixture may further comprise stabilizers and other conventional additives like for example initiators, release agents and regulators. Such auxiliaries are known to those skilled in the art.

Examples of compounds which may be used as stabilizers are benzotriazoles, HALS products or sterically hindered phenols, and mixtures of the abovementioned components. HALS compounds are sterically hindered amines, as described by way of example in JP3047856A. These hindered amine light stabilizers scavenge the free radicals which form during exposure to radiation.

Examples of compounds used as regulators are carbocyclic regulators, sulphur-containing regulators, γ-terpines and terpinols.

The initiators used may comprise any of the commercially available free-radical initiators, such as 2,2′-azobis(isobutyronitrile).

Finally the monomer mixture comprises impact modifying additives in an amount of 0,5 to 35% by weight, preferably 1 to 30% by weight and particular preferred 5 to 25% by weight, based on the weight of the molding cast solution respectively molding syrup.

There are no particular limitations to usable impact modifiers. Core—shell I as well as core-shell I—shell II impact modifiers, as known in the art and commercially available, or mixtures of both can be used.

The inventors, however, found out, that very good results may be achieved with core-shell I-shell II impact modifier having the following composition:

Core comprising (sum of all components listed
below is 100% by weight):

| | | |
|---|---|---|
| 94-97.9% | by weight | of methyl methacrylate |
| 2-5% | by weight | of ethyl acrylate |
| 0.1-1% | by weight | of crosslinker |

Shell I comprising (sum of all components listed
below is 100 by weight)

| | | |
|---|---|---|
| 78-86.9% | by weight | of butyl acrylate |
| 13-20% | by weight | of styrene or α- |
| | | methylstyrene |
| 0.1-2% | by weight | of crosslinker |

Shell II comprising (sum of all components listed
below is 100 by weight)

| | | |
|---|---|---|
| 38-98% | by weight | of methyl methacrylate |
| 2-10% | by weight | of ethyl acrylate |
| 0-40% | by weight | of butyl acrylate |
| 0-10% | by weight | of styrene |
| 0-2% | by weight | of crosslinker |

Monomer mixtures for preparation of above mentioned impact modifiers may in addition comprise conventional additives like for example initiators, regulators, emulsifiers etc.

Examples of crosslinker which may be used in the impact modifier (core or shell I or shell II) are di(meth)acrylates, divinylbenzenes, and allyl (meth)acrylates. It is also possible to use a mixture of the crosslinker components. The core: shell I :shell II ratio is preferably 20-30: 30-50: 20-40% by weight. Examples of impact modifiers and their preparation are described in EP 0 828 772, or U.S. Pat. No. 3,793,402 or U.S. Pat. No. 4,690,986.

It is possible to use the impact modifier not only in pure powder form but also in the form of a master batch.

The underlying composition used for the master batch may be a commercially available PLEXIGLAS® moulding composition, such as PLEXIGLAS®7H or PLEXIGLAS®6N or PLEXIGLAS®7N. These moulding compositions are marketed by Evonik Röhm GmbH.

The master batch may be prepared by a conventional melt coagulation/compounding process. The amount of impact modifier in the master batch may be from 10 to 50% by weight, based on the total weight of the master batch.

An example of a very preferred composition for the matrix material for the inventive plastic moulding and/or for the master batch is shown in Table 2 (sum of all components mentioned below is 100% by weight):

TABLE 2

| | | |
|---|---|---|
| 96.68-99.49% | by weight | of methyl methacrylate |
| 0-0.3% | by weight | of an unsaturated carboxylic acid |
| 0-1% | by weight | of crosslinker |
| 0.5-1% | by weight | of stabilizers |
| 0-0.01% | by weight | of regulator |
| 0-0.01% | by weight | of initiator |
| 0.01-1.0% | by weight | of release agent |

A very preferred composition of the plastic mouldings of the inventive windows is shown in Table 3 (sum of all components is 100% by weight):

TABLE 3

| | | |
|---|---|---|
| 58.869-98.988% | by weight | of methyl methacrylate |
| 0-3% | by weight | of an unsaturated carboxylic |
| | | acid and/or an unsaturated |
| | | carbolic acid ester |
| 0.5-35% | by weight | of an impact modifier |
| 0-1% | by weight | of crosslinker |
| 0.5-1% | by weight | of stabilizer |
| 0.001-0.1% | by weight | of initiator |
| 0.01-1.0% | by weight | of release agent and |
| 0.001-0.031% | by weight | of regulator |

A mixture of ingredients according to Table 3 is preferably polymerized by a casting process and the resulting product subsequently coated with an abrasion resistance and/or weathering resistance coating.

Windows according to the present invention preferably have a thickness of from 2 to 25 mm, particular preferred 2 to 15 mm, very particular preferred 2 to 10 mm and especially preferred 3 to 7 mm. A thickness below the claimed range would lead to insufficient mechanical properties. A thickness above the range would cause an unnecessary extra weight and extra cost. It would also imply increased production problems.

As mentioned before, the inventive windows can be used as front, side and rear window of cars and other vehicles. Thus, they are preferably clear and/or colorless. It is however, very easily possible to colourate the plastic material in any desired colour. This might in particular be desirable for side, rear windows and roof windows.

It is further very preferred that the inventive windows exhibit haze values of less than 5,5 at 60° C., and less than 2.0 at 40° C., and less than 1 at room temperature (23° C.) measured according to AST DIN EN ISO 13803. This is of particular importance for rear or front windows with a heating unit and ensures that the inventive windows can also be used in cars and trucks which are regularly used in very could regions of the world.

In particular for front and rear windows, a light transmittance of the inventive windows at least 92% is preferred.

The examples disclosed below are intended for improved understanding of the present invention but do not restrict the scope of the invention in any way.

### EXAMPLES

Sheets with dimensions 2100×1290×4.0 mm have been produced by a conventional cell casting process between glass plates.

The inventive composition used was a mixture made from 80% by weight of methylmethacrylate and 20% by weight of an impact modifier mixture (master batch) with the following composition:
63.254% by weight, based on the master batch, of PLEXIGLAS®Y7N, available from Evonik Rhöm GmbH
36.746% by weight, based on the master batch, of an impact modifier with core-shell I-shell II structure
   Core: 23% by weight, based on the impact modifier, of a copolymer made from methylmethacrylate, ethylacrylate and allylmethacrylate in weight ratios 95,7 to 4,0 to 0,3% by weight.
   Shell I: 47% by weight, based on the impact modifier, of a copolymer made from the following: butyl acrylate, styrene and allylmethacrylate in weight ratios 81,2 to 17,5 to 1,3% by weight.
   Shell II: 30% by weight, based on the impact modifier, of a copolymer made from the following: 96% by weight of methylmethacrylate and 4% by weight of ethyl acrylate.

The sheet obtained was subsequently coated with an abrasion resistance coating.

As Comparison Example 1 a commercially available polymer sheet PLEXIGLAS®GS 233, without impact modifier, produced by Evonik Röhm GmbH by a cast process, as Comparison Example 2 a commercial available extruded acrylic sheet (Acrylite FF), as Comparison Example 3 a polycarbonate sheet, as Comparison Example 4 a laminated and as Comparison Example 5 a tempered glass sheet were tested.

All sheets mentioned above where tested in an “Interior Loading Headform Test” at room temperature. In this test sample sheets of 26″×26″ of above mentioned materials were used. The maximum load until breakage and the maximum deflection was determined and are given in Table 4 below.

TABLE 4

| | Max | Max | | | |
|---|---|---|---|---|---|
| | Load | Deflection | Type of | Thickness | |
| Material | (lbs) | (Inches) | Breakage | of Sheet | |
| Inventive Sheet | 14175 | 5.11 | Ductile | 5.3 | mm |
| | | | then | | |
| | | | Chards | | |
| Comparison | 2246 | 1.96 | Large | 6 | mm |
| Example 1 | | | Chards | | |
| Comparison | 3228 | 2.47 | Large | 6 | mm |
| Example 2 | | | Chards | | |
| Comparison | 13069 | 5.59 | Ductile | 5.5 | mm |
| Example 3 | | | then | | |
| | | | Chards | | |
| Comparison | 481 | 0.507 | Small | 4.75 | mm |
| Example 4 | | | contained | | |
| | | | pieces | | |

| | | | | |
|---|---|---|---|---|
| Comparison | 657 | 0.533 | Small | 4.70 |
| Example 5 | | | Pieces | |

Table 4 confirms that an acrylic sheet according to the present invention shows tremendous improvements in the maximum load capacity and the maximum deflection compared to other acrylic sheets even when the inventive sheet has a lower thickness.

Polycarbonate sheets show slightly worse performance in the maximum load value. Polycarbonate sheets, however, were found to show significantly worse weathering resistance compared to the inventive sheet.

Glass sheets showed the worst performance.

As consequence, the sheets according to the present invention lead to a significant weight saving and security compared to glass sheets as conventionally used. Compared to other plastic sheets, the sheets of the invention lead to tremendous performance improvements. Thus, windows according to the invention are the only plastic windows fulfilling the strong requirements of the automotive industry.

1. A window comprising a coated plastic moulding,
wherein
the plastic moulding is made of a polymethylmethacrylate based polymer having a molecular mass of at least 750.000 g/mol and comprises an impact modifier,
and
the plastic moulding is coated with an abrasion resistance coating, a weathering resistance coating, or both.

2. The window according to claim 1, wherein the coated plastic moulding is obtained by a process comprising:
polymerizing a mixture comprising
58,869-98.988% by weight of methyl methacrylate
0-3% by weight of an unsaturated carboxylic acid, an unsaturated carbolic acid ester, or both
0.5-35% by weight of an impact modifier
0-1% by weight of a crosslinker
0.5-1% by weight of a stabilizer
0.001-0.1% by weight of an initiator
0.01-1.0% by weight of a release agent and
0.001-0.031% by weight of a regulator
by a casting process, to obtain a moulding; and
coating the moulding with an abrasion resistance coating, a weathering resistance coating, or both.

3. The window according to claim 2,
wherein a master batch comprising the polymethylmethacrylate based polymer and the impact modifier is prepared and further processed to produce a polymerizable starting material for the polymerizing.

4. The window according to claim 3,
wherein
the master batch comprises 10-50% by weight of the impact modifier and 50-90% by weight of the polymethylmethacrylate based polymer.

5. The window according to claim 2,
wherein
the polymerizing comprises dissolving an impact modifier or a polymethylmethacrylate based polymer comprising an impact modifier in a solution comprising methylmethacrylate or in a methylmethacrylate which has undergone incipient polymerization, then
pouring a resulting solution or syrup is into a cell or between steel belts and
carrying out polymerization.

6. The window according to claim 1,
wherein
the impact modifier is a core-shell or core-shell I-shell II impact modifier.

7. The window according to claim 1,
wherein
the impact modifier is core-shell I-shell II impact modifier,
the core comprises, based on a total of 100% by weight:
94-97, % by weight of methyl methacrylate;
2-5% by weight of ethyl acrylate; and
0.1-1% by weight of a crosslinker,
the shell I comprises, based on a total of 100 by weight:
78-86,9% by weight of butyl acrylate;
13-20% by weight of styrene or α-methylstyrene; and
0.1-2% by weight of a crosslinker, and
the shell II comprises, based on a total of 100% by weight:
38-98% by weight of methyl methacrylate;
2-10% by weight of ethyl acrylate;
0-40% by weight of butyl acrylate;
0-10% by weight of styrene; and
0-2% by weight of a crosslinker.

8. The window according to claim 1,
wherein
the polymethylmethacrylate polymer is made of a monomer mixture comprising:
96,68-99,49% by weight of methyl methacrylate;
0-0.3% by weight of an unsaturated carboxylic acid;
0-1% by weight of a crosslinker;
0.5-1% by weight of a stabilizer;
0-0.01% by weight of a regulator;
0-0.01% by weight of an initiator; and
0.01-1.0% by weight of a release agent,
wherein a sum of all components is 100% by weight.

9. The window according to claim 1,
wherein the window is at least one selected from the group consisting of a rear window, a front window,
a window of a passenger car, and a window of a truck.

10. The window according to claim 1,
wherein the window
has a thickness of from 2 to 25 mm,
the window is clear,
the window is colourless
the window is coloured,
the window has a haze of less than 5.5 at 60° C., less than 2.0 at 40° C., and less than 1 at room temperature (23° C.)
the window has a light transmittance of at least 92%,
or any combination thereof.

11. The window according to claim 1,
wherein the window
has a thickness of from 2 to 15 mm,
the window is clear,
the window is colourless
the window is coloured,
the window has a haze of less than 5.5 at 60° C., less than 2.0 at 40° C., and less than 1 at room temperature (23° C.)
the window has a light transmittance of at least 92%,
or any combination thereof.

12. The window according to claim 1,
wherein the window
has a thickness of from 2 to 10 mm,
the window is clear,
the window is colourless
the window is coloured,
the window has a haze of less than 5.5 at 60° C., less than 2.0 at 40° C., and less than 1 at room temperature (23° C.)
the window has a light transmittance of at least 92%,
or any combination thereof.

13. The window according to claim 1,
wherein the window
has a thickness of from 3 to 7 mm,
the window is clear,
the window is colourless
the window is coloured,
the window has a haze of less than 5.5 at 60° C., less than 2.0 at 40° C., and less than 1 at room temperature (23° C.)
the window has a light transmittance of at least 92%,
or any combination thereof.
